(19) United States
(12) Patent Application Publication
(10) Pub. No.: US 2015/0228159 A1
(43) Pub. Date: Aug. 13, 2015

(54) Community Gaming System

(71) Applicant: Ainsworth Game Technology Limited, Newington (AU)

(72) Inventor: Jason Meyer, Abbotsford (AU)

(21) Appl. No.: 14/621,357

(22) Filed: Feb. 12, 2015

(30) Foreign Application Priority Data
Feb. 13, 2014 (AU) 2014900429

(51) Int. Cl. G07F 17/32; G07F 17/34

(52) U.S. Cl. CPC G07F 17/3274; G07F 17/3213; G07F 17/34

(57) ABSTRACT

The invention provides a gaming system comprising at least a first and a second electronic gaming machine electronically linked to each other. The first electronic gaming machine comprises a display adapted to simultaneously display game symbols of at least the first and second electronic gaming machines and an electronic game controller for controlling the display of game symbols on the display. The electronic game controller causes the first electronic gaming machine to allow the player of the first electronic gaming machine to wager on an outcome of a game on at least the second electronic gaming machine. Where the outcome results in the award of a prize by the second electronic gaming machine, the player of the first electronic gaming machine receives a prize associated with the prize awarded by the second electronic gaming machine. A gaming method is also provided.

### BACKGROUND

The invention relates to a system and method of community or cooperative based gaming adapted for use with electronic gaming machines and in an electronic gaming machines employing a feature game associated with a game played on the electronic gaming machine. The invention has been developed primarily for use as system for a plurality of electronic gaming machines and will be described hereinafter by reference to this application. The invention may additionally apply to games of chance operated or adapted for use with electronic gaming machines. More specifically, electronic gaming machines may include slot machines or poker machines.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional electronic gaming machines have typically focused on a single player experience, wherein a single person plays a game of chance (such as a slot machine). The game is activated and the player wins or loses based on the outcomes of the single machine that they are playing.

These electronic games of chance have generally relied upon the player being singly engaged with the electronic gaming experience. Interactions with other players of slot machines and poker machines are typically limited and may reduce the player's individual gaming experience.

Other non-electronic forms or types of games of chance such as physical card games including poker or blackjack have previously encourage cooperative play or community play between individual players by allowing players to make side bets or ante bets on the outcomes of other player's card hands. This cooperative play may generally make games of chance more enjoyable and makes them more community centric.

It is an object of the invention to overcome or substantially ameliorate one or more of the disadvantages of prior art, or at least to provide a useful alternative.

It is an object of the invention in at least one preferred form to provide a gaming system and method that encourages interest in community based game play between two or more players of electronic gaming machines.

### SUMMARY

According to a first aspect of the invention, there is provided a gaming system comprising:

at least a first and a second electronic gaming machine electronically linked to each other;

wherein said first electronic gaming machine comprises:
a display for displaying a game, wherein said game comprises game symbols and predetermined winning combinations of randomly selected game symbols in said game award prizes to a player, and wherein said display is adapted to simultaneously display game symbols of at least said first and second electronic gaming machines; and
an electronic game controller for controlling the display of game symbols on the display;

wherein a player of said first electronic gaming machine makes an initial bet to play said game on said first electronic gaming machine; and

said electronic game controller causes said first electronic gaming machine to allow said player of said first electronic gaming machine to wager on an outcome of a game on at least the second electronic gaming machine wherein said outcome results in the award of a prize by said second electronic gaming machine, said player of said first electronic gaming machine receives a prize associated with said prize awarded by said second electronic gaming machine.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Preferably, said electronic gaming machine comprises a housing and an input device. It is preferred that said input device comprises one or more buttons on said housing, said buttons being in electronic communication with said electronic game controller to transmit player commands to said electronic game controller. More preferably, said buttons are arranged on a console of said housing. Alternatively or additionally, said input device comprises a touch sensitive surface on said display for receiving player commands, said touch sensitive surface being in electronic communication with said electronic game controller to transmit player commands to said electronic game controller.

Preferably, said housing comprises a value transfer mechanism for paying said prizes to said player using value in an amount equal to an awarded prize. More preferably, said value transfer mechanism also receives value from said player to initiate said bet. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Preferably, the electronic gaming machine comprises a mobile electronic gaming device. More preferably, said mobile electronic gaming device comprises a handheld electronic device. In one preferred form, said handheld electronic device comprises a handheld electronic gaming device or a smart phone. Alternatively, said electronic gaming machine comprises a computer. More preferably, said computer is connected to a communication network.

According to a second aspect of the invention, there is provided a gaming system comprising:

at least a first and a second electronic gaming machine electronically linked to each other;

wherein said first electronic gaming machine comprises:
a housing having a display for displaying a game comprising game symbols and an electronic game controller in electronic communication with said display for controlling the display of game symbols on the display;
wherein said game comprises predetermined winning combinations of randomly selected game symbols in said game award prizes to a player of said first electronic gaming machine, wherein said display is adapted to simultaneously display game symbols of at least said first and second electronic gaming machines; and
an input device for receiving commands from said player of said first electronic gaming machine to operate said first electronic gaming machine and initiate play of said game on said display, said input device being in electronic communication with said electronic game controller;
wherein said electronic game controller in response to a command from said player of said first electronic gaming machine via said input device commences play of said game by randomly selecting game symbols and transmitting a signal to said display to display said game symbols;

wherein said player of said first electronic gaming machine makes an initial bet to play said game on said first electronic gaming machine; and

said electronic game controller causes said first electronic gaming machine to allow said player of said first electronic gaming machine to wager on an outcome of a game on at least the second electronic gaming machine wherein said outcome results in the award of a prize by said second electronic gaming machine, said player of said first electronic gaming machine receives a prize associated with said prize awarded by said second electronic gaming machine.

The second aspect of the invention preferably has the preferred features of the first aspect of the invention stated above, where applicable.

According to a third aspect of the invention, there is provided a gaming method for at least a first and second electronic gaming machine, each of said electronic gaming machines having a display for displaying a game, wherein said game comprises game symbols and predetermined winning combinations of randomly selected game symbols in said game award prizes to a player and an electronic game controller for controlling the display of game symbols on the display, said method comprising:

electronically linking said at least first and second electronic gaming machines to each other;

simultaneously displaying on the display of said first electronic gaming machines game symbols of said at least first and second electronic gaming machines;

enabling a player of said first electronic gaming machine to make an initial bet to play said game on said first electronic gaming machine;

said electronic game controller enabling said player of said first electronic gaming machine to wager on an outcome of a game on at least said second electronic gaming machine, wherein said outcome results in the award of a prize by said second electronic gaming machine; and

awarding to said player of said first electronic gaming machine a prize associated with said prize awarded by said second electronic gaming machine.

The third aspect of the invention preferably has the preferred features of the first aspect of the invention stated above, where applicable.

According to a fourth aspect of the invention, there is provided a gaming method for at least a first and second electronic gaming machine, each of said electronic gaming machines comprising a housing having a display for displaying a game, wherein said game comprises game symbols and predetermined winning combinations of randomly selected game symbols in said game award prizes to a player; an electronic game controller inside said housing for controlling the display of said game symbols for playing said game on said display; and an input device for receiving commands from said player to operate said electronic gaming machine, said input device being in electronic communication with said electronic game controller, the method comprising:

electronically linking said at least first and second electronic gaming machines to each other;

said electronic game controller of said first electronic gaming machine transmitting a signal to said display of said first electronic gaming machine to simultaneously display on the display of said first electronic gaming machines game symbols of said at least first and second electronic gaming machines;

said electronic game controller of said first electronic gaming machine enabling a player of said first electronic gaming machine to make an initial bet to play said game on said first electronic gaming machine;

said electronic game controller of said first electronic gaming machine enabling said player of said first electronic gaming machine to wager on an outcome of a game on at least said second electronic gaming machine, wherein said outcome results in the award of a prize by said second electronic gaming machine; and

said electronic game controller of said first electronic gaming machine awarding to said player of said first electronic gaming machine a prize associated with said prize awarded by said second electronic gaming machine.

The method preferably has the preferred features of the third aspect of the invention stated above, where applicable.

According to a fifth aspect of the invention, there is provided a computer system comprising a central processing unit configured for communication with at least a first and second electronic gaming machine, wherein said computer system is configured to perform the method of the second aspect of the invention.

According to a sixth aspect of the invention, there is provided a computer program configured to perform the method of the third or fourth aspects of the invention.

According to a seventh aspect of the invention, there is provided a non-transitory carrier medium carrying computer executable code that, when executed on a central processing unit configured for communication with at least a first and second electronic gaming machine, causes the central processing unit to perform the method of the third or fourth aspects of the invention.

### BRIEF DESCRIPTION OF THE DRAWINGS

Preferred embodiments of the invention will now be described, by way of example only, with reference to the accompanying drawings in which:

FIG. 1 depicts a schematic block diagram of the system layout according a first preferred embodiment of the present invention;

FIG. 2 is depicts an example screen display of a first slot machine forming part of the system shown in FIG. 1, and

FIG. 3 depicts an example of a community screen forming part of the system shown in FIG. 1;

FIG. 4 depicts a further example of the community screen shown in FIG. 3;

FIG. 5 is a perspective view of an exemplary slot machine used in the first embodiment of the invention; and

FIG. 6 is a schematic drawing of an electronic game controller for the slot machine of FIG. 5.

### DETAILED DESCRIPTION OF VARIOUS EMBODIMENTS

The present invention will now be described with reference to the following examples which should be considered in all respects as illustrative and non-restrictive.

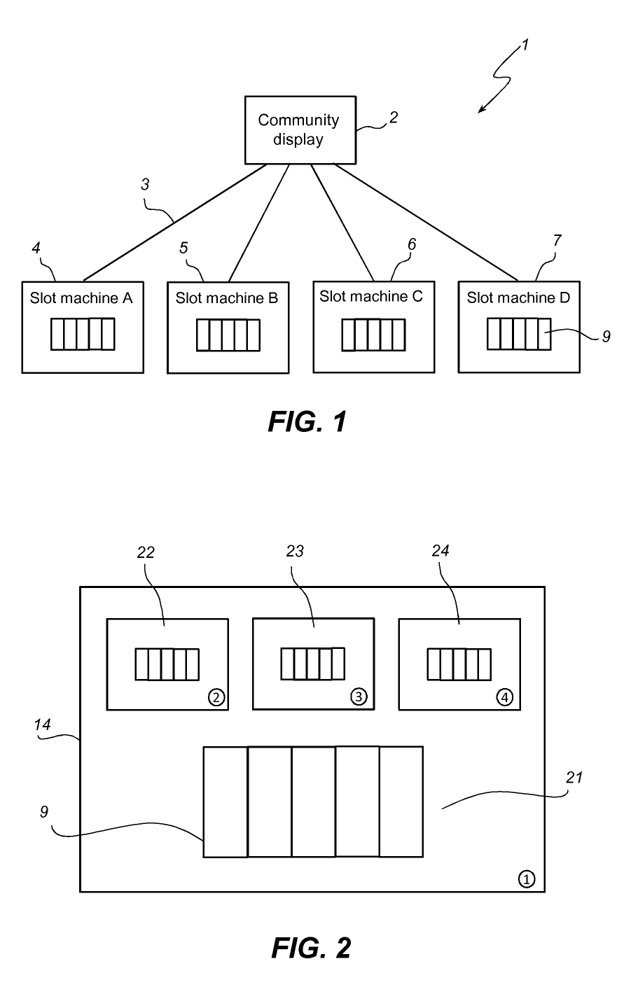

Preferably, the present invention may be described in reference to a first preferred embodiment, wherein the first preferred embodiment is depicted in FIGS. 1 to 6 and described in detail in this specification.

The first preferred embodiment is a system or method directed to improve the gaming experience of players by allowing them to interact with each other but also cooperate in a limited fashion to play electronic games of chance. In this first embodiment, the preferred electronic game of chance is defined as a slot machine or poker machine.

Typically, poker machines or slot machines offer play of a game that comprises an array of rows and columns, the columns defining “reels”. The array of reels is usually depicted on a screen or viewing window and are visually “spun” (so as to appear to rotate on the screen) to display various combinations of randomly selected game symbols at the end of the spin, which constitutes a play of the game. The combinations of game symbols being determined by predetermined pay lines comprising at least one game position of each reel. These game symbols may be in the form of familiar symbols recognisable to the players such as: letters, stylized images, stylized animated symbols, pictures, numbers or playing card images. The arrays may include various configurations and layouts of a number of game symbols shown on each reel compared to the number of reels shown. These arrays are usually described by the respective numbers of rows and columns, and as such may include arrays of 3×3, 3×5 (the current industry standard), 5×5, etc.

Slot machines and poker machines award prizes to players wherein a predetermined winning combination of game symbols appearing on a player-selected payline is matched in the game of chance with the associated paytable. The amount awarded is typically calculated based on the paytable outcome multiplied by the wager or bet placed by the player prior to commencing the particular game.

Referring to FIG. 1, a system 1 is provided according to the first preferred embodiment of the present invention, wherein the system generally includes a series or plurality of slot machines electronically linked to a community display or screen 2.

In this embodiment, the series of slot machines includes four machines that have been labelled “slot machine A” 4, “slot machine B” 5, “slot machine C” 6 and “slot machine D” 7. The preferred system may include more or less than four slot machines in its configuration or layout, however four machines is generally preferred for reasons relating to screen layout and general game playability.

Each slot machine is electronically connected to the community display 2 via wires 3, wireless networking protocols, or Ethernet connections. Preferably, the community display 2 may include within its structure and configuration a server computer (not shown in the figures), wherein the server computer coordinates the actions of the arrays in the slot machines and the information displayed on the community display 2. Preferably, the community display 2 is a relatively large display screen (even compared to the individual screens of the slot machines) or monitor wherein this community display 2 is adapted to be clearly seen and viewed by all players of the array of slot machines 4, 5, 6 and 7.

The system is preferably adapted to allow players to play the games of chance on their respective slot machines in regular fashion, however the outcomes and game play are also preferably shown on the community display 2 in real time.

Preferably, the said server computer may be further adapted to allow electrical or network connection to an external gaming technology management system that allows the monitoring of financial details of the slot machines and the community. These external gaming technology management systems are standardized and generally operated by the gaming venue owner or operator.

Preferably, the system 1 is adapted to allow players to play their individual slot machines in a standard manner wherein the player is allowed to place a bet or wager and select paylines. The game is then activated and the reels rotate. The slot machine after a predetermined time interval stops the spinning reels and displays a randomized pattern of game symbols on the shown array of reels. Where the game symbols on a selected payline matches at least one predetermined winning combination as shown on a paytable linked to the slot machine, the player wins and is awarded a prize equal to the amount shown on the paytable in respect of the specific winning combination shown. The prize may be multiplied by the size of original bet made by the player relative the minimum bet.

Referring to FIG. 2, this figure depicts a preferred sample screen display 14 of an individual slot machine. In this example, the screen 14 is that of slot machine A 4. However, the screen 14 would be reproduced and modified for the other three slot machines linked to the server in this configuration. The screen 14 is divided into several different playable areas or regions. The screen 14 is preferably an LCD, or OLED with touch screen technology incorporated into its design. Players may able to activate the game or selections in the games by touching the screen in the relevant places. It is noted that other types of screens may be utilized.

In this embodiment, a first player may be positioned at slot machine A 4 and this first player may play a single player game on the slot machine A 4. The single player game is shown using the screen region 21, wherein in this example screen region 21 includes five reels 9 of a standard 3×5 array. The first player may play this region in a similar way or manner to regular single player slot machines that are not connected to the system of the present invention.

However, the screen 14 also includes three other regions 22, 23, 24 that relate to games being played on the other linked slot machines. In this example, a hypothetical second player is positioned at and playing slot machine B 5, a hypothetical third player is positioned at slot machine C 6, and a hypothetical fourth player is positioned at and playing slot machine D 7. The first player preferably can view or see the games of the other three players in real time. The amount of sub-regions on this screen 14 may be modified dependent on the number of linked slot machines to the system. That is, as the number of linked slot machines increase, so do the number of sub-regions by the same amount.

The second screen sub-region 22 relates to a real time inset of the slot machine B 5. Preferably, the screen sub-region 22 shows a similar image to the respective region 21 being seen by the second player on slot machine B 5. It is noted that preferably, the first player cannot see any of the second player's wagers, second player's payline selections, or the total amount of credits of the second player. Most of the other details of the second player's game or games are reported in real time in sub-region 22. Additionally, the system provides the first player with an option to bet or wager on the outcomes of the game being played by the second player on slot machine B 5.

Preferably, the first player may use the preferred touch screen 14 and depress the sub-region 22 to select the wagering options on the second player's game. The first player preferably is allowed by the system to vary their bet or wager on each game independently. This betting or wagering on other player's games is typically called ante betting or side betting. If a winning combination is depicted on the second player's screen as shown in sub-region 22 and the first player placed a wager on the outcome of the second player's game, the system will award an appropriate prize derived from the paytable based on the amount wagered. Preferably, the prize base paytables are the same for all linked slot machine consoles. However, the paytables may be increased or decreased in accordance with the betting or wagering behaviour of the respective players, or independently of this betting behaviour.

Screen sub-region 23 and 24 depicts the respective screens of slot machine C 6 and slot machine D 7. On the screen 14, the respective screens of the machine consoles have been numbering from 1 to 4 to make it easier for the first player to understand which screens he or she is viewing.

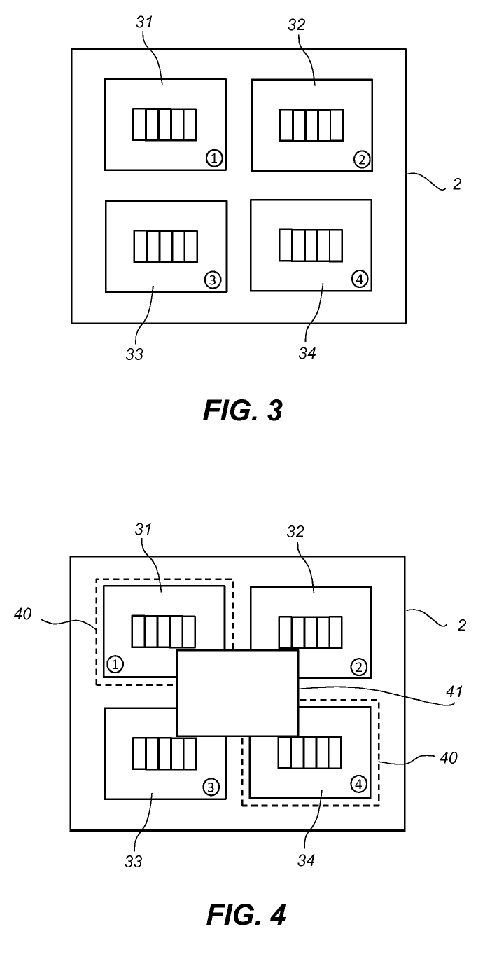

Depicted in FIG. 3 is an example image of the community display 2, wherein the community display 2 comprises four regions 31, 32, 33 and 34. Each of the regions preferably display real time information about the games being played on the four associated slot machines 4, 5, 6 and 7. The information displayed preferably does not show the total credits of each player nor does it show the individual winnings of each player and nor does it show wagering patterns of each player. Rather, the community display 2 shows the reels of each game being played and highlights winning combinations.

Referring to FIG. 4, the community display 2 is again displayed, but in this example, a community feature game has been triggered by the players. Preferably, the system described within this embodiment may include a community feature game trigger. The community feature game may be activated by the one or more of the players satisfying a predetermined trigger event in their game played on their respective slot machine.

For example, a player may activate the community feature game trigger event when a winning combination of trigger event symbols is displayed on the reels of the respective slot machine that they are playing. The system detects that the trigger event has occurred and displays the community feature game as a popup box 41 on the community display 2. In this configuration, all of the players of the linked slot machines may be given an opportunity to participate in the community feature game. The community feature game may include a type of mini game that is playable by players and may result in the allocation of free spins to each participating player or bonus credits, which are added to their total credits. The mini games may be in the form of further slot machine type games or binary guessing competitions based on standard feature games used in other forms of slot machines.

Generally, the community feature game play may be limited by the maximum time the community feature game is playable or the maximum amount of games that could be played on the community feature game upon a single activation or trigger. Once the community feature has reached its maximum limit, the community feature game finishes and is deactivated until the community feature game trigger event is met again by one of the players. When the community feature is deactivated, the popup box 41 is also deactivated and removed from the screen 14.

Preferably, the community display 2 may also be used to encourage new players to play slot machines with no players. This is aimed to encourage maximum game play of the linked slot machines A 4 to D 7 and increase the number of community game play activations. Preferably, the likelihood or probability of the trigger event occurring may be increased with increased numbers of players playing the linked slot machines.

Preferably, once the community feature game is triggered, the system determines whether each player is qualified to participate. This qualification may be determined based on whether the player has met predetermined conditions including but not limited to: minimum length of time player has been playing a respective slot machine; minimum amount of total credits within the respective slot machine; calculations of minimum thresholds based of wagering amounts; and the habits of the respective players. If the system determines that the player is qualified to participate in the community feature game, the system will request a confirmation of participation from the player.

In respect of FIG. 4, screen regions 31 and 34 have been highlighted, as indicated by reference numeral 40. This highlighting 40 indicates to all players that the respective players playing slot machine A 4, and slot machine D 7 have confirmed their willingness to participate in the community feature.

In alternate versions of the community feature game, the community feature game trigger event may be triggered cooperatively by all players. For example, the community feature game trigger event may occur when at least one trigger symbol is shown on each of the screens of all linked slot machines or by at least a majority of them. A person skilled in the art will appreciate that numerous different winning combinations of triggering symbols could be used across the linked slot machines. Further, the trigger symbols may also be automatically held and displayed on the screen of each slot machine until the community feature game trigger event is fully activated by the cooperative interaction of the players.

In other embodiments, each of the linked slot machines have secondary displays for showing the outcomes of the games played on the other linked slot machines, instead of a community display being used. This permits the slot machines to be physically located remotely from each other, thus reducing the footprint of the gaming system where the invention is implemented to a gaming venue with pre-existing electronic gaming machines. Thus, the invention can be implemented on or retrofitted to existing electronic gaming machines without having to physically move the machines together in proximity to a community display.

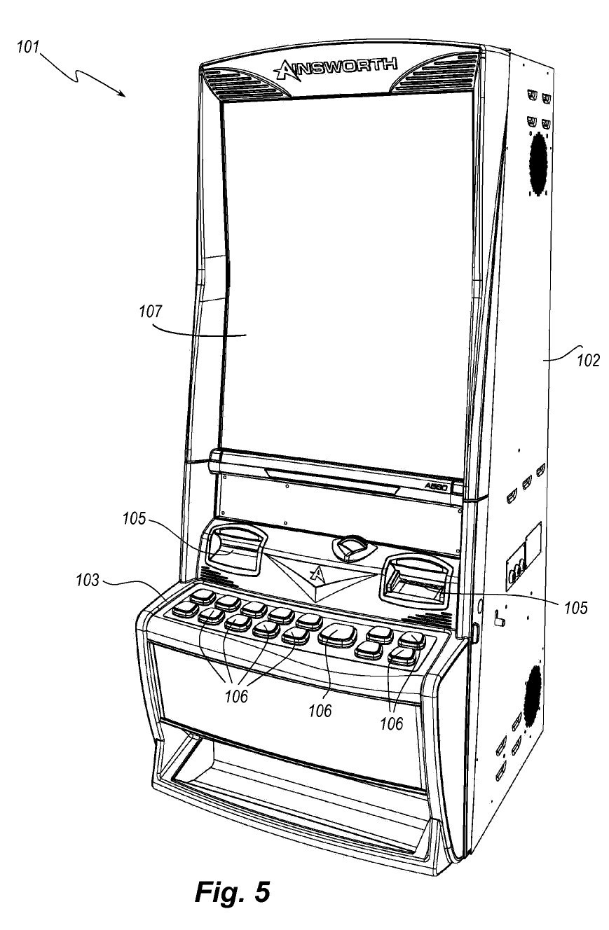

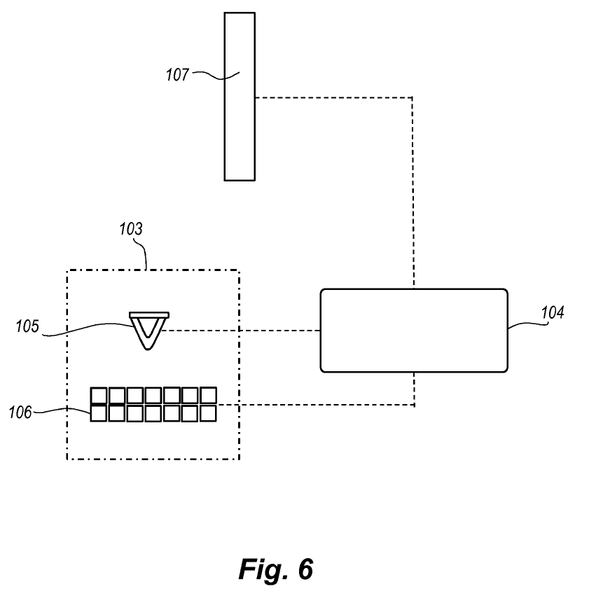

Referring to FIG. 5, an exemplary electronic gaming machine or slot machine 101 used in the first embodiment of the invention includes a cabinet 102, a console 103 and an internal electronic game controller 104 (see FIG. 6). The console 103 has various input devices including vending slots 105 for receiving monetary bets and a plurality of buttons 106 for actuation by a player. It will be appreciated that in other embodiments the vending slots 105 may be replaced with other types of value input/value output devices, such as a coin acceptor, a paper currency acceptor, a ticket reader and/or printer or a card reader and/or writer.

The vending slots 105 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 101. Other forms of value include gaming tokens, paper, tickets, vouchers, and any other object representative of value.

The electronic game controller 104 is generally in the form of a central processing unit, such as a computer, and is in electronic communication with a display in the form of a video display screen 107, as well as various input devices on the console 103, as best shown in FIG. 6. Typically, the electronic game controller 104 also comprises a random access memory (RAM) associated with the central processing unit, the RAM being used to store program instructions and transient data related to the operation of the electronic game controller and hence the electronic gaming machine 101. The RAM contains a body of program instructions for implementing a game on the electronic gaming machine 101, as discussed in more detail below. The central processing unit or processor may also be operatively associated with a further storage device, such as a hard disk drive, which is used for long-term storage of program components and data relating to the electronic game controller 104 and/or the electronic gaming machine 101, including a database for game performance data, as well as information gathered from users. It is also appreciated that a person skilled in the art would readily understand the location and use of the electronic game controller 104 in the electronic gaming machine 101.

The electronic game controller 104 will transmit and receive signals to and from each of the input devices and the display 107, usually via wired connections but can include wireless modes of electronic communication, such as WLAN. In the case of the vending slots 105 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 104, which then determines whether the minimum bet level has been reached. If so, the electronic game controller 4 will permits play of the game on the electronic gaming machine 101. If not, the electronic game controller 104 will send a signal to the display 107 to show a message requesting further value to be added to the electronic gaming machine 101.

The electronic game controller 104 is programmed to provide a game, which may include a base game and/or feature game on the video display screen 107 of the electronic gaming machine 101 for play by a player. The video display screen 107 can be divided into a lower playing area and an upper information display area.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way, the invention can be implemented in various ways on electronic gaming machines. In a further aspect, the invention includes a computer system comprising a central processing unit (such as a computer or computational processor) configured for communication with at least the first and second electronic gaming machines to perform the invention. In a yet another aspect, the invention includes a non-transitory carrier medium carrying computer executable code that, when executed on a central processing unit configured for communication at least the first and second electronic gaming machines, causes said central processing unit to perform the invention. In this case, the non-transitory carrier medium includes an external hard drive, a memory device, including a memory card, smart card, a radio frequency identification (RFID) device, USB key, magnetic card or other electronic storage device.

By providing a gaming system of linked electronic gaming machines that permits players to separately wage on the outcomes of games being played on other linked electronic gaming machines, the invention encourages cooperative game play without sacrificing the ability of each player to play their own game individually. Moreover, the invention generates excitement and interest in playing one of the linked electronic gaming machines, as it creates variety in game play and provides additional opportunities for players to play more than one electronic gaming machine at the same time. Furthermore, the ability to increase the probability of triggering a community feature game based on the number of active players further generates excitement and interest in playing the linked electronic gaming machines. In all these respects, the invention represents a practical and commercially significant improvement over the prior art.

Although the invention has been described with reference to specific examples, it will be appreciated by those skilled in the art that the invention may be embodied in many other forms.

1. A gaming system comprising:
at least a first and a second electronic gaming machine electronically linked to each other;
wherein said first electronic gaming machine comprises:
a display for displaying a game, wherein said game comprises game symbols and predetermined winning combinations of randomly selected game symbols in said game award prizes to a player, and wherein said display is adapted to simultaneously display game symbols of at least said first and second electronic gaming machines; and
an electronic game controller for controlling the display of game symbols on the display;
wherein a player of said first electronic gaming machine makes an initial bet to play said game on said first electronic gaming machine; and
said electronic game controller causes said first electronic gaming machine to allow said player of said first electronic gaming machine to wager on an outcome of a game on at least the second electronic gaming machine wherein said outcome results in the award of a prize by said second electronic gaming machine, said player of said first electronic gaming machine receives a prize associated with said prize awarded by said second electronic gaming machine.

2. The gaming system of claim 1, wherein the game symbols and outcomes of games are shown in real time on the display.

3. The gaming system of claim 1, wherein the display of the first electronic gaming machine displays the gaming symbols of a game being played on a second electronic gaming machine.

4. The gaming system of claim 1, wherein said game of said second electronic gaming machine comprises a base game and a feature game, and wherein said outcome is an outcome of said feature game of the second electronic gaming machine.

5. The gaming system of claim 1, wherein the gaming system comprises four electronic gaming machines.

6. The gaming system of claim 1, wherein said player receives a prize that is the same as said prize awarded by the second electronic gaming machine.

7. The gaming system of claim 1, wherein said player receives a prize that is a multiple of said prize awarded by the second electronic gaming machine.

8. The gaming system of claim 7, wherein said player receives a prize that is equal to said prize awarded by the second electronic gaming machine multiplied by said initial bet.

9. The gaming system of claim 1, wherein the gaming system includes a community display which is adapted to be seen by all players of said electronic gaming machines, and wherein the community display is further adapted to display selected data from all of said electronic gaming machines.

10. The gaming system of claim 9, wherein at least one electronic gaming machine includes a community trigger event, wherein said community trigger event is triggered and allows for cooperative play of a feature game displayed on the community display and wherein said cooperative play is adapted for two or more players of the electronic gaming machines.

11. The gaming system of claim 10, wherein cooperative play is permitted for each player of an electronic gaming machine that has satisfied a threshold qualification event as determined by the gaming system.

12. The gaming system of claim 1, wherein each of said electronic gaming machines comprises a secondary display, wherein said outcome of said game on said second electronic gaming machine is displayed on said secondary display.

13. The gaming system of claim 1, wherein said outcome of said game on said second electronic gaming machine is displayed on each display of said electronic gaming machines.

14. A gaming method for at least a first and second electronic gaming machine, each of said electronic gaming machines having a for displaying a game, wherein said game comprises game symbols and predetermined winning combinations of randomly selected game symbols in said game award prizes to a player and an electronic game controller for controlling the display of game symbols on the display, said method comprising:
electronically linking said at least first and second electronic gaming machines to each other;
simultaneously displaying on the display of said first electronic gaming machine the game symbols of said first and second electronic gaming machines;
enabling a player of said first electronic gaming machine to make an initial bet to play said game on said first electronic gaming machine;
said electronic game controller enabling said player of said first electronic gaming machine to wager on an outcome of a game on at least said second electronic gaming machine, wherein said outcome results in the award of a prize by said second electronic gaming machine; and
awarding to said player of said first electronic gaming machine a prize associated with said prize awarded by said second electronic gaming machine.

15. The gaming method of claim 14, comprising displaying the game symbols and said outcome in real time on said display of said first electronic gaming machine.

16. The gaming method of claim 14, wherein said game of said second electronic gaming machines comprises a base game and a feature game, and wherein said outcome is an outcome of said feature game of the second electronic gaming machine.

17. The gaming method of claim 14, comprising electronically linking two additional electronic gaming machines to said first and second electronic gaming machines, and wherein said simultaneous displaying step comprises simultaneously displaying the game symbols of said additional electronic gaming machines with the game symbols of said second electronic gaming machine on the display of said first electronic gaming machine.

18. The gaming method of claim 14, wherein said awarding step comprises awarding said player a prize that is the same as said prize awarded by the second electronic gaming machine.

19. The gaming method of claim 14, wherein said awarding step comprises awarding said player a prize that is a multiple of said prize awarded by the second electronic gaming machine.

20. The gaming method of claim 19, wherein said prize is equal to said prize awarded by the second electronic gaming machine multiplied by said initial bet.

21. The gaming method of claim 14, comprising providing a community display visible by all players of said electronic gaming machines, wherein said community display displays selected data from all of said electronic gaming machines.

22. The gaming method of claim 21, comprising enabling cooperative play of a community feature game displayed on the community display, wherein said community feature game is triggered by a community feature trigger event occurring on at least one electronic gaming machine and said cooperative play occurs between at least two players of said electronic gaming machines.

23. The gaming method of claim 22, wherein said cooperative play enabling step comprises determining whether each said player of said electronic gaming machines satisfies a threshold qualification event.

24. The gaming method of claim 14, comprising providing a secondary display on each said electronic gaming machine, wherein each said secondary display displays said outcome of said game on said second electronic gaming machine.

25. The gaming method of claim 14, comprising displaying said outcome of said game on said second electronic gaming machine on the display of each said electronic gaming machine.
